(19) United States
(12) Patent Application Publication
(10) Pub. No.: US 2021/0400514 A1
(43) Pub. Date: Dec. 23, 2021

(54) MEASURING CHANNEL PERFORMANCE IN WIRELESS LOCAL AREA NETWORKS

(71) Applicant: BRITISH TELECOMMUNICATIONS PUBLIC LIMITED COMPANY, LONDON (GB)

(72) Inventors: Francis SCAHILL, London (GB); Simon RINGLAND, London (GB)

(21) Appl. No.: 17/309,042

(22) PCT Filed: Oct. 3, 2019
(86) PCT No.: PCT/EP2019/076828

§ 371 Date: Apr. 16, 2021

(30) Foreign Application Priority Data
Oct. 16, 2018 (EP) 18200675.9

(51) Int. Cl. H04W 24/10; H04B 17/318

(52) U.S. Cl. CPC H04W 24/10; H04W 84/12; H04B 17/318

(57) ABSTRACT

There is herein disclosed a method of determining a working communication channel for use by a first access point in a WLAN, the method including making one or more performance measurements in respect of a communication channel at a proxy access point in the WLAN, the proxy access point being different to the first access point, and using the one or more performance measurements to determine a working communication channel for use by a first access point.

### PRIORITY CLAIM

The present application is a National Phase entry of PCT Application No. PCT/EP2019/076828, filed Oct. 3, 2019, which claims priority from EP Patent Application No. 18200675.9, filed Oct. 16, 2018, each of which is hereby fully incorporated herein by reference.

### TECHNICAL FIELD

This disclosure concerns wireless local area networks (WLANs). In particular, this invention relates to the performance of communication channels in a WLAN.

BACKGROUND

It is desirable for the quality of signals transmitted between devices in a WLAN be high enough to ensure effective transmission of data. To this end it is known to measure and compare the performance of the communication channels available within the WLAN, and to use only the better-performing channels in communications. Measuring the performance of a channel may include, for example, measuring the noise on the channel.

One known technique for measuring the performance of a channel is as follows. An access point communicates with a client device on a channel in the conventional way. When it is desired to obtain performance information in relation to other channels, communication on the working channel is paused while the access point performs a brief “scan” of the other channels. By “scan” it is meant that the access point switches through a series of channels, spending a fraction of a second on each and in that time making performance measurements. A disadvantage with such an approach is that it requires communication on the working channel to be paused. This results in a break in data flow which may be noticeable to a user.

### SUMMARY

The present disclosure addresses and/or overcomes these and/or other disadvantages associated with the prior art.

According to a first aspect of the disclosure there is provided a method of determining a working communication channel for use by a first access point in a WLAN, the method comprising making one or more performance measurements in respect of a communication channel at a proxy access point in the WLAN, the proxy access point being different to the first access point, and using the one or more performance measurements to determine a working communication channel for use by the first access point.

These features enable a method to be performed which determines a working channel for the first access point using performance measurements measured at a second access point, the second access point being different to the first access point. As it makes performance measurements on behalf of the first access point, the second access point acts as a proxy and so is referred to here as the proxy access point. The performance measurements measured at the proxy access point may be similar to those that would have been measured at the first access point. This is particularly so if the proxy access point is experiencing similar environmental conditions to the first access point which may be the case, if, say, the proxy access point is located close to the first access point. The disclosure may be of use, for example, where the first access point is unable to make performance measurements on the communication channel. This could be because it is communicating with a client on a different channel.

The method may further comprise using the determined working communication channel as the working communication channel of the first access point. “Working communication channel” may be understood to mean the channel on which the first access point is configured to send data to and/or receive data from a client device or a plurality of client devices.

The method may further comprise identifying an access point in the WLAN for use as a proxy access point. The proxy access point may be the access point located closest to the first access point. Identifying the proxy access point may involve determining which access point has the highest signal strength as seen by the first access point. This determination may be made using RSSI measurements.

The method may include switching the working channel of the proxy access point to the communication channel before making the performance measurements. The method may further comprise comparing the one or more performance measurements with one or more performance measurements made in respect of a second communication channel. The method may comprise using the outcome of that comparison to select a working channel for the first access point. In particular, the method may comprise using the performance measurements made by the proxy channel to determine a ranking score for the first communication channel. The ranking score may be compared with the ranking scores of other channels available to the first access point to determine a working channel for the first access point.

A master access point may instruct the proxy access point to make performance measurements on the first communication channel. The proxy access point may send the performance measurements to the master access point for processing.

The method may further comprise identifying a further access point that is capable of communicating with the client device of the proxy access point. This is useful if, for example, the proxy access point is not idle and, instead, is communicating with a client device. The method may further comprise communicating between the further access point and the device. This may comprise disassociating the device with the proxy access point and associating the device to the further access point. Communicating between the further access point and the device may take place on the working channel of the further access point. The method may further comprise switching the working channel of the proxy access point to the first communication channel. The method may further comprise making performance measurements on the first communication channel. The method may further comprise terminating communication between the further access point and the device. This may comprise disassociating the device with the further access point. The method may further comprise re-starting communication between the proxy access point and the device. This may comprise re-associating the device to the proxy access point.

The method may further comprise, at a second access point, sending data to, and/or receiving data from, the client device. The second access point may be the proxy access point. The method may further comprise switching the working channel of the first access point from the second communication channel to the first communication channel. The method may further comprise making performance measurements in respect of the first communication channel at the first access point. These features enable a method to be performed in which the clients of the first access point are “relocated” to the second access point in order to “free up” the first access point to make performance measurements on a desired channel. This has the benefit that performance measurements can be obtained from a desired channel more quickly than with known techniques as there is no need to wait until the access point becomes idle.

The method may further comprise associating the device to the second access point. The method may further comprise terminating communication between the device and the first access point. This may comprise dissociating the device from the first access point. Dissociating the device from the first access point may take place before associating the device to the second access point.

The method may further comprise determining an appropriate access point in the WLAN to use as the second access point. This may involve determining which of the access points in the WLAN are capable of communicating with the client device. This may further involve determining which of the access points in the WLAN is most capable of communicating with the client device.

Sending data to, and/or receiving data from, the device at a second access point may take place on the working channel of the second access point.

The method may include determining whether the first access point has a radio which is idle. If it is determined that the first access point has a radio which is idle, the method may include switching the working channel of the first access point to the first communication channel and making performance measurements in respect of the first communication channel.

The method may include identifying the first communication channel. This may include determining which of the first access point's channels has provided the least recent performance data. This may further include determining, from the multiple channels available to all access points in the WLAN, the channel and its corresponding access point for which the least recent performance data has been obtained.

Performance measurements may include measurements of the noise on a channel. Noise on the channel may include interference from sources including but not limited to microwave ovens and analogue TV senders. Alternatively or in addition, performance measurements may include measurements of the contention level on the channel. The contention level may be a measure of the amount of contending neighboring Wi-Fi traffic operating on the channel. Measuring the contention level may involve measuring the number of other access points operating on the channel in the vicinity of the access point at issue. Alternatively or in addition, performance measurements made at an access point may include measurements of the access point's utilization of the channel. This may be a measure of the proportion of time during which the access point is actively sending or receiving data.

The method may further include comparing the performance of the first communication channel with the performance of the other channels available to the first access point. The working channel for the first access point may be chosen using this comparison. This comparison may involve determining a ranking score for the first communications channel and for the other channels available to the first access point. The ranking score for a given channel may be determined using the performance measurements associated with that channel.

Identifying a second access point includes determining which access point in the WLAN is best able to communicate with the client device. This may include the client measuring the signal strength of the access points in the WLAN and comparing the measured signal strengths. The first access point may instruct the client to make the signal strength measurements. This may be achieved by sending an 802.11k measurement request to the client. The client may report the results to the first access point which may report the results to a master access point. The master access point may compare the measurements and may perform the step of identifying a second access point using this comparison. In some embodiments there are a plurality of client devices. In these embodiments identifying a second access point includes determining which access point in the WLAN is best able to communicate with each of the client devices. Each feature mentioned in this description as relating to a client or a client device should be understood to also relate to a plurality of clients or client devices.

Communicating between the second access point and the device may comprise the device sending data to the second access point, the data being intended for transmission beyond the second access point. The data may be intended for transmission over the internet. Alternatively, the data may be intended for transmission to a destination on the local LAN. Communicating between the second access point and the device may comprise initiating communication between the second access point and the device on the working channel of the second access point.

The method may further comprise switching the working channel of the first access point back from the first communication channel to the second communication channel. Communication may then restart between the first access point and the device on the second communication channel. This may comprise dissociating the device from the second access point and may comprise re-associating the device with the first access point.

In some embodiments the method is repeated using a new first communication channel. In such embodiments the first access point may be a different access point to the first access point used in the first iteration of the method. The method may be repeated a plurality of times.

According to a second aspect of the disclosure there is provided a data carrier comprising machine-readable instructions for performing the method according to the first aspect of the disclosure .

### BRIEF DESCRIPTION OF DRAWINGS

For illustration only, a specific embodiment of the disclosure will now be described in detail with reference to the accompanying drawings, in which:

FIG. 1 is a schematic drawing of the network of the invention.

FIG. 2 is a schematic drawing of the network of the invention after certain method activities according to embodiments of the disclosure have been performed.

FIG. 3 is a schematic drawing of the network of the disclosure after other method activities according to embodiments of the disclosure have been performed.

FIG. 4 is a flow chart showing the method of the disclosure .

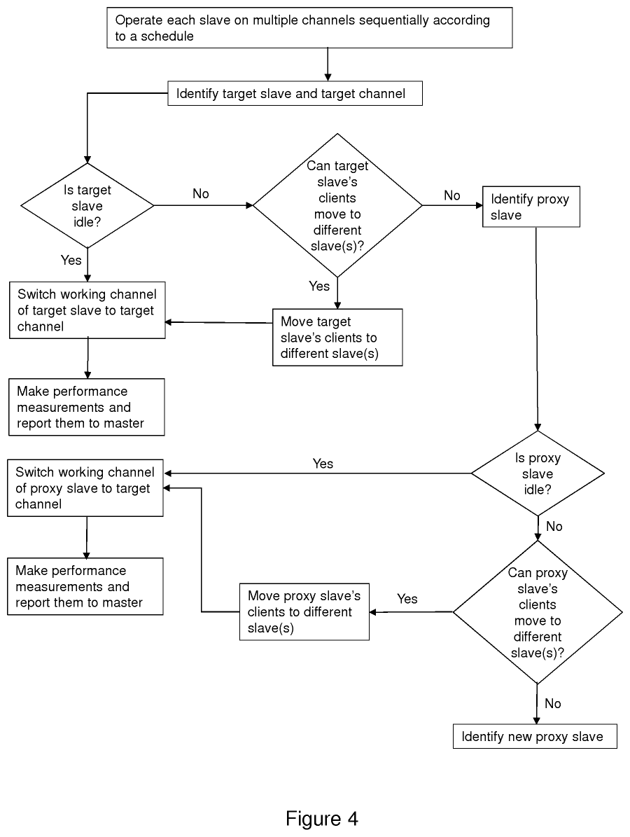

### DETAILED DESCRIPTION

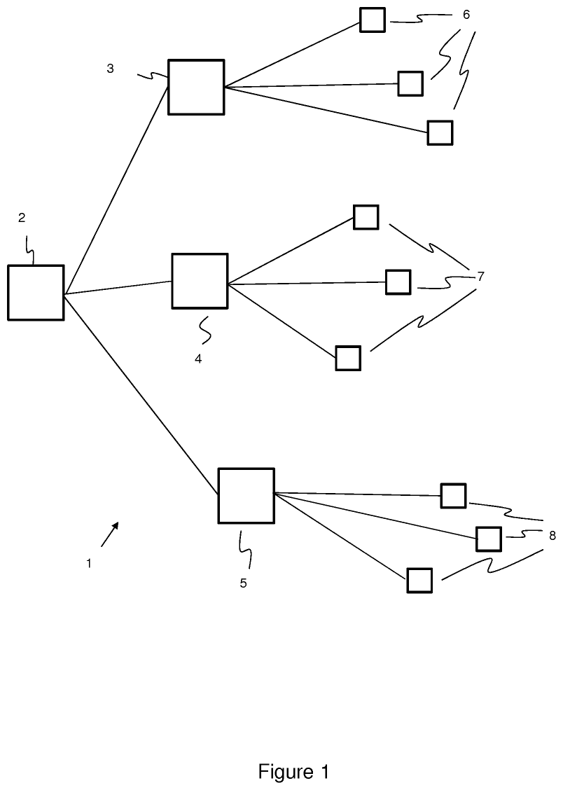

FIG. 1 shows a Wi-Fi network in accordance with the invention. There is a master access point 2 (which will be referred to as master AP 2) which can communicate wirelessly with three slave access points 3,4,5 (which will be referred to here as slaves 3,4,5). Slave 3 can communicate wirelessly with three client devices labelled 6 in FIG. 1. Slave 4 can communicate wirelessly with three client devices labelled 7 in FIG. 1. Slave 5 can communicate wirelessly with three client devices labelled 8 in FIG. 1. In the specific embodiment described here, each of the three slaves has one radio which it uses for communicating with its respective client devices.

Each slave 3,4,5 can communicate with its respective devices on one of several different channels within the frequency band of operation of that slave 3,4,5. The quality of each channel is primarily affected by two factors: interference (e.g. from microwave ovens and analogue TV senders); and other Wi-Fi traffic. These two factors reduce the quality of communication on a given channel. However, the extent to which the two factors reduce the quality of the channel varies from one channel to another and also varies over time. It is desirable for each slave to communicate with its clients on the best-performing channel in terms of signal quality.

To this end, each slave selects a particular channel as its working channel for a period of one week. Therefore, for one week the slave 3 communicates with its clients 6 on that working channel. At regular intervals over the course of the week, the slave 3 measures the level of noise on the working channel, the level of neighbor contention on the working channel and its “own utilization”. By neighbor contention level it is meant the proportion of the time that slaves other than the slave 3 and its associated clients are putting sufficient energy onto the channel that the channel appears busy and transmission between the slave 3 and its clients 6 is not possible. The “own utilization” measurement is the amount of time that data is being transmitted from or received by the slave 3. Specifically, this is the proportion of each minute that the slave 3 is sending or receiving data.

The slave 3 sends the measured data to the master 2. The master 2 uses the measured data to determine the average noise level and neighbor contention level for the slave 3. When the week has elapsed, the slave 3 switches its radio to a different channel and proceeds to communicate with its clients 6 on that channel for one week. Over the course of that week, the slave 3 makes regular measurements of the noise and contention levels and sends them to the master 2. This process repeats using each of the slave's available channels as the working channel in accordance with a schedule. The master 2 compares the determined average noise level for each channel and also compares the determined average contention level for each channel from these comparisons determines the worst performing channel. The slave 3 then cycles through each of the channels again, each for one week as before, except for the determined worst performing channel which is left out of this cycle. As in the first cycle, the slave 3 makes noise and contention measurements for each working channel which are averaged and compared as before. As before, the worst performing channel is excluded from the subsequent cycle.

If, at the end of each week-long period, a working channel is in use (i.e. not idle) then the change in working channel is delayed. Furthermore, if a channel has been excluded from the cycle for some time, the master 2 will not have any recent performance data in respect of that channel. For these reasons, it may be that the master has received insufficient recent noise and contention data in respect of one or more channels to enable it to make a meaningful performance comparison between all the channels. Therefore, the master 2 monitors the amount of performance data it has received from the slaves and identifies one channel of one slave in respect of which it has received the least recent performance data. This channel will be referred to as the “target channel” and the slave as the “target slave”. In this description, slave 3 will be considered to be the target slave.

The master 2 asks the target slave 3 whether or not its radio is idle. If the radio is idle, the master 2 instructs the target slave 3 to switch its radio to the target channel for a period of time, and to make performance measurements on the target channel over the course of that period. When the period has elapsed, the target slave 3 returns to its normal channel schedule. The target slave 3 sends the measured performance data to the master 2 which uses it in the channel performance comparison process referred to above.

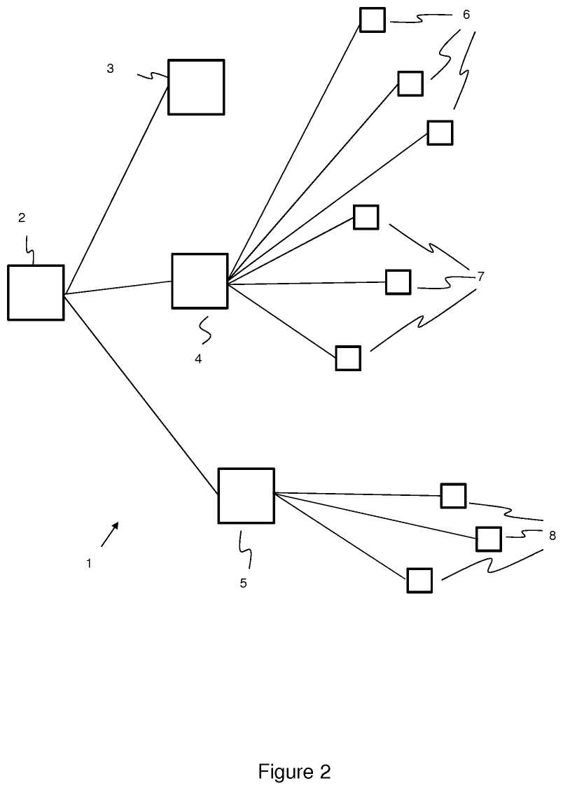

If the target slave's radio is not idle, the master 2 instructs the target slave 3 to test whether the target slave's clients would be able to switch to communicating with one or more of the other slaves 4,5 rather than the target slave 3. The target slave 3 does this by sending an 802.11k measurement request to each client 6, asking it to measure and report the signal strength at which it sees each of the other slaves 4,5. The target slave 3 reports this information to the master 2. If the signal strength is sufficient for the clients 6 to switch to another slave(s), the master instructs the target slave 3 to switch its clients 6 to that other slave(s) using 802.11v BSS transition requests. The target slave 3 does so, then switches its radio to the target channel for a period of time and makes performance measurements on the target channel over the course of that period. This situation is shown in FIG. 2. The target slave 3 sends the measured performance data to the master 2 which uses it in the channel performance comparison process referred to above. When the period has elapsed, the target slave 3 returns to its normal channel schedule. The master 2 then performs a load-rebalancing procedure which may involve switching the clients which were moved to a different slave back to the target slave 3. That procedure will not be described in detail here.

If it is not possible to switch the clients 6 to a different slave 4,5, the master determines which of the other slaves 4,5 is located nearest to the target slave 3. The master 2 does this by analyzing RSSI measurements for signals sent between the target slave 3 and neighboring slaves 4,5. The slave determined as the nearest to the target slave 3 will be referred to as the proxy slave. In the presently described embodiment, slave 4 is the proxy slave.

The master 2 asks the proxy slave 4 whether or not its radio is idle. If the radio is idle, the master 2 instructs the proxy slave 4 to switch its radio to the target channel for a period of time, and to make performance measurements on the target channel over the course of that period. When the period has elapsed, the proxy slave 4 returns to its normal channel schedule. The proxy slave 4 sends the measured performance data to the master 2 which uses it in the channel performance comparison process referred to above.

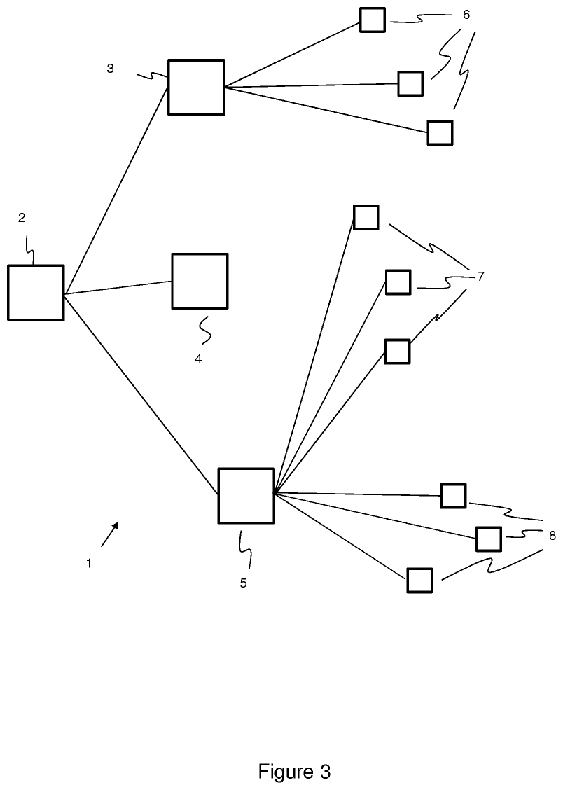

If the proxy slave's radio is not idle, the master 2 instructs the proxy slave 4 to test whether the proxy slave's clients would be able to switch to communicating with one or more of the other slaves 4,5 rather than the proxy slave 4. The proxy slave 4 does this by sending an 802.11k measurement request to each client 7, asking it to measure and report the signal strength at which it sees each of the other slaves. The proxy slave 4 reports this information to the master 2. If it is possible for the clients 7 to switch to another slave(s), the master instructs the proxy slave 4 to switch its clients to that other slave(s) using 802.11v BSS transition requests. The proxy slave 4 does so, then switches its radio to the target channel for a period of time and makes performance measurements on the target channel over the course of that period. This situation is shown in FIG. 3. In FIG. 3, the proxy slave 4 has switched its client to slave 5. When the period has elapsed, the proxy slave 4 sends the measured performance data to the master which uses it in the channel performance comparison process referred to above.

As proxy slave 4 is located in the vicinity of target slave 3, the communication conditions experienced by proxy slave 4 are similar to those experienced by target slave 3. Therefore, the averaged noise and contention measurements that the master 2 obtains using the proxy slave's performance data will be similar to those which it would have obtained had it used the target channel's performance data. Therefore, the master 2 uses the averaged noise and contention measurements obtained using the proxy slave's data as if they had been obtained using the target slave's data in the channel performance comparison process referred to above.

When the period has elapsed, the proxy slave 4 returns to its normal channel schedule. The master 2 then performs a load-rebalancing procedure which may involve switching the clients which were moved to a different slave(s) back to the proxy slave 4. This procedure will not be described in detail here.

If it is not possible to switch the clients to a different slave, the master determines which slave other than the proxy slave 4 is the next nearest to the target slave 3. The master 2 does this by analyzing RSSI measurements for signals sent between the target slave 3 and its neighboring slaves. The process described above is then repeated with this newly identified slave as the proxy slave.

1. A method of determining a working communication channel for use by a first access point in a wireless local area network (WLAN), the method comprising:
making one or more performance measurements in respect of a communication channel at a proxy access point in the WLAN, the proxy access point being different from the first access point and
using the one or more performance measurements to determine a working communication channel for use by the first access point.

2. The method as claimed in claim 1, further comprising using the determined working communication channel as the working communication channel of the first access point.

3. The method as claimed in claim 1, further comprising comparing the one or more performance measurements with one or more performance measurements made in respect of a second communication channel.

4. The method as claimed in claim 3, further comprising using an outcome of the comparing to select a working communication channel for the first access point.

5. The method as claimed in claim 1, further comprising using the one or more performance measurements made by the proxy access point to determine a ranking score for the first communication channel.

6. The method as claimed in claim 5, wherein the ranking score is compared with ranking scores of other channels available to the first access point to determine a working communication channel for the first access point.

7. The method as claimed in claim 1, comprises further comprising determining an access point in the WLAN for use as the proxy access point.

8. The method as claimed in claim 7, further comprising determining which access point is located closest to the first access point.

9. The method as claimed in claim 8, further comprising determining which access point has a highest signal strength as seen by the first access point.

10. The method as claimed in claim 9, further comprising using RSSI measurements to determine which access point has the highest signal strength.

11. The method as claimed in claim 1, wherein a master access point instructs the proxy access point to make the one or more performance measurements on the first communication channel.

12. The method as claimed in claim 11, wherein the proxy access point sends the one ormore performance measurements to the master access point for processing.

13. The method as claimed in claim 1, the method further comprising disassociating a device from the proxy access point and associating the device to a further access point.

14. The method as claimed in claim 13, further comprising disassociating the device from the further access point.

15. A non-transitory computer-readable storage medium storing machine-readable instructions for, when loaded on a computer and executed thereby, performing the method as claimed in claim 1.
